(19) United States
(12) Patent Application Publication
(10) Pub. No.: US 2013/0196292 A1
(43) Pub. Date: Aug. 1, 2013

(54) METHOD AND SYSTEM FOR MULTIMEDIA-BASED LANGUAGE-LEARNING, AND COMPUTER PROGRAM THEREFOR

(71) Applicants: Forrest BRENNEN, Oxford (GB); Philip Glenny EDMONDS, Oxford (GB); John Patrick NONWEILER, Oxford (GB); Alexander ZAWADZKI, Oxford (GB)

(72) Inventors: Forrest BRENNEN, Oxford (GB); Philip Glenny EDMONDS, Oxford (GB); John Patrick NONWEILER, Oxford (GB); Alexander ZAWADZKI, Oxford (GB)

(73) Assignee: SHARP KABUSHIKI KAISHA, Osaka (JP)

(21) Appl. No.: 13/360,857

(22) Filed: Jan. 30, 2012

(51) Int. Cl. G09B 19/06; G09B 19/00

(52) U.S. Cl. 434/157; 434/156

(57) ABSTRACT

A multimedia-based language learning method and system which includes implementing via one or more processors the steps of—receiving an input of multimedia content, where the multimedia content comprises a plurality of component tracks; separating the multimedia content into multimedia sections in which the plurality of component tracks share a same start and end time; retrieving a user model representing a learner's knowledge and/or interest in a foreign language; automatically assigning one or more learner-specific evaluations to the multimedia sections by evaluating one or more of the component tracks based on the user model within each of the multimedia sections; and adapting the multimedia content within the multimedia sections based on the assigned learner-specific evaluations to render the multimedia content more useful to the learner for learning the foreign language.

### TECHNICAL FIELD

The present invention relates to a system, method and program for enabling language learners to use multimedia contents in their study.

### BACKGROUND ART

There is a desire to use foreign-language multimedia contents in the course of language-learning. Such contents are often created for the enjoyment of native speakers of the foreign language, and a simple way to integrate these into the language learning process will increase their value while providing both enjoyment and authentic examples of real-world speech to a learner. It will additionally create the option for learners to choose how they study a language by allowing them to select any multimedia content to learn from. However, it is difficult to make most multimedia content accessible or useful as a language-learning tool: dialog vocabulary can be colloquial or simply too advanced for the learner, speech patterns and cadence can be too fast, and background noise can interfere with comprehension, for example.

The most straightforward way to make foreign-language content accessible to learners is to simply create the content for that purpose. This is a staple of most foreign-language-learning courses today. There are many advantages to this approach. For example, the content can be exactly as difficult as a lesson requires, including all concepts, vocabulary, and other items being taught, and not including anything considered too difficult for the lesson. Furthermore, it is not necessary to translate, evaluate, or otherwise process the content to make it accessible, as would be required if some pre-existing content was used. However, custom content is limited in several regards: creation can be time-consuming, the content is generally only useful for the lesson it is designed for, and it is necessarily tailored to a specific lesson as opposed to a specific student, which makes it less able to address specific student needs.

A different approach is to manually adapt existing contents designed or created for native speakers (known as “authentic contents”) so that they can be used for foreign-language learning. Examples of this can be seen in services such as Chou Jimaku (www.chou-jimaku.com) or English Attack! (www.english-attack.com). Such an approach usually involves the manual or semi-automatic annotation of the content to make it comprehensible or the selection of only those sections which fall within the difficulty of the lesson. This approach has the advantage of providing more real-world material for the learner to engage with, making the transition from the classroom to the real world easier. It can also enable a student to learn from material which they would enjoy outside the classroom (such as a subtitled foreign film). This approach suffers from high overhead in obtaining, annotating, or otherwise manually or semi-automatically processing the content, as well as the previously-mentioned difficulty in adapting the content to a given student instead of to a lesson.

In an attempt to remove the manual- or semi-automatic-related overhead in the previous method, a fully automatic approach may be used. Such a technique involves extracting a single part from the multimedia content, such as the subtitles for a particular language, and then using it to automatically test the user. An example of this is described in US 2006/0039682A1 to W. Chen et al. (published Feb. 23, 2006; hereinafter “the '682 application”), wherein a DVD player is described which automatically extracts the subtitles from a given DVD, converts them into synthesized speech, and then evaluates the user's accuracy in replicating that speech. This method has the advantages of low overhead and versatility, requiring a single piece of software used in the DVD player, which then enables any subtitled DVD media to function as a language-learning source. This method suffers from same disadvantage regarding adapting the content to a given student, as well as the drawback of only teaching pronunciation. Additionally, the method is necessarily limited to DVD media only.

Attempts have been made to automatically adapt authentic contents to specific users. US2009/0307203A1 to G. Keim et al. (published Dec. 10, 2009; hereinafter “the '203 application”) describes a method for filtering the results of a search engine query to return only the most useful ones to a learner. This is accomplished by evaluating the text of the search results relative to a “learner model,” such as which vocabulary words the learner knows, how well they recall those words, and which words they are studying in the current lesson. This method has low-overhead and versatility advantages similar to the '682 application, requiring a single piece of software which then enables any learner model to function as a filter for language learning. However, as the '203 application functions via a search engine, it is by definition concerned with searching for content suitable to the learner, as opposed to allowing the learner to select any content of their choosing; while the learner is able to specify search terms, the precise piece of content that is returned is decided by the method, not by the learner. Furthermore, the search engine aspect of the method relies (as most search engines do) primarily on textual information to find content, and while other types of information may be included (such as audio), it must first be converted to text before the method can process it. The method is thus limited in the way it can judge the quality of content with non-text-based elements (such as video).

A similar method to the '203 application is also used as part of Carnegie Mellon's REAP project, and is described by J. Brown and M. Eskenazi (Retrieval of authentic documents for reader-specific lexical practice. Proceedings of InSTIL/ICALL Symposium 2004. Venice, Italy). As with the '203 application, search results are filtered based on vocabulary or other word-based values collected as part of a “user model” (conceptually similar to the “learner model” of the previous paragraph) and the result is a collection of texts designed to match the user's level of language proficiency. Also similar to the '203 application, REAP is concerned primarily with discovery of new text documents, as opposed to evaluation of learner-selected media, and works via text-based search methods alone.

The conventional art thus fails to provide a method and system which allows a foreign-language learner to select authentic multimedia content of their choosing which is then automatically evaluated and adapted to the learner. An object of the invention is to provide a method and system for adapting multi-track digital multimedia content to make it easier for a foreign-language learner to select and use in language-learning.

### SUMMARY OF INVENTION

According to an aspect of the invention, a multimedia-based language learning method is provided which includes implementing via one or more processors the steps of—receiving an input of multimedia content, where the multimedia content comprises a plurality of component tracks; separating the multimedia content into multimedia sections in which the plurality of component tracks share a same start and end time; retrieving a user model representing a learner's knowledge and/or interest in a foreign language; automatically assigning one or more learner-specific evaluations to the multimedia sections by evaluating one or more of the component tracks based on the user model within each of the multimedia sections; and adapting the multimedia content within the multimedia sections based on the assigned learner-specific evaluations to render the multimedia content more useful to the learner for learning the foreign language.

According to another aspect of the invention, the user model comprises vocabulary words the learner knows and/or is interested to learn.

In accordance with another aspect, the plurality of component tracks comprises a subtitle component track in the foreign language.

In accordance with still another aspect, the step of adapting the multimedia content comprises adapting content of the subtitle component track.

According to yet another aspect, the subtitle component track is evaluated based on the user model in the step of assigning the one or more learner-specific evaluations.

According to still another aspect, the subtitle component track is evaluated based on at least one of colloquialisms, grammar, vocabulary, speech difficulty, and accuracy in matching accompanying dialog in an audio component track.

In accordance with another aspect, the subtitle component track is adapted by at least one of selectively displaying subtitle text, displaying the subtitle text in the foreign language and/or a native language, highlighting relevant words or phrases in the subtitle text, and concealing words in the subtitle text familiar to the learner.

According to another aspect, the subtitle component track is adapted by displaying the subtitle text in the native language or a combination of the foreign and native language.

In accordance with another aspect, the multimedia content is adapted only in the multimedia sections determined to be most useful or relevant to the learner.

According to another aspect, the step of adapting the multimedia content comprises respectively selecting for each multimedia section whether to display the multimedia content based on the assigned learner-specific evaluations.

According to still another aspect, an audio component track within the plurality of component tracks is evaluated based on the user model in the step of assigning the one or more learner-specific evaluations.

In yet another aspect, the audio component track is evaluated based on at least one of number of speakers, background noise and speaking speed.

According to another aspect, when the background noise of the audio component track is evaluated as being an obstacle to dialog which would otherwise be accessible to the learner, the audio component track is adapted by reducing the background noise.

According to yet another aspect, a video component track within the plurality of component tracks is evaluated based on the user model in the step of assigning the one or more learner-specific evaluations.

In yet another aspect, the one or more learner-specific evaluations include a plurality of learner-specific evaluations.

In still another aspect, a one of the plurality of learner-specific evaluations is adjusted taking into account another one of the learner-specific evaluations.

According to still another aspect, the method includes accepting feedback from the learner based upon which the one or more learner-specific evaluations are modified.

According to yet another aspect, the feedback is the learner's responses to a quiz.

In accordance with another aspect, the input of multimedia content is received from at least one of an optical disk and streaming media.

According to still another aspect, a multimedia-based language learning system is provided which includes one or more processors executing a program to carry out the steps of—receiving an input of multimedia content, where the multimedia content comprises a plurality of component tracks; separating the multimedia content into multimedia sections in which the plurality of component tracks share a same start and end time; retrieving a user model representing a learner's knowledge and/or interest in a foreign language; automatically assigning one or more learner-specific evaluations to the multimedia sections by evaluating one or more of the component tracks based on the user model within each of the multimedia sections; and adapting the multimedia content within the multimedia sections based on the assigned learner-specific evaluations to render the multimedia content more useful to the learner for learning the foreign language.

In accordance with another aspect, the user model comprises vocabulary words the learner knows and/or is interested to learn.

According to yet another aspect, the plurality of component tracks comprises a subtitle component track in the foreign language.

In yet another aspect, the step of adapting the multimedia content comprises adapting content of the subtitle component track.

According to still another aspect, the subtitle component track is evaluated based on the user model in the step of assigning the one or more learner-specific evaluations.

In accordance with another aspect, the subtitle component track is evaluated based on at least one of colloquialisms, grammar, vocabulary, speech difficulty, and accuracy in matching accompanying dialog in an audio component track.

According to still another aspect, the subtitle component track is adapted by at least one of selectively displaying subtitle text, displaying the subtitle text in the foreign language and/or a native language, highlighting relevant words or phrases in the subtitle text, and concealing words in the subtitle text familiar to the learner.

With respect to another aspect, the subtitle component track is adapted by displaying the subtitle text in the native language or a combination of the foreign and native language.

According to another aspect, an audio component track within the plurality of component tracks is evaluated based on the user model in the step of assigning the one or more learner-specific evaluations.

According to another aspect, a non-transitory, computer-readable medium having stored thereon a program when executed by a computer carries out a method of multimedia-based language learning, including receiving an input of multimedia content, where the multimedia content comprises a plurality of component tracks; separating the multimedia content into multimedia sections in which the plurality of component tracks share a same start and end time; retrieving a user model representing a learner's knowledge and/or interest in a foreign language; automatically assigning one or more learner-specific evaluations to the multimedia sections by evaluating one or more of the component tracks based on the user model within each of the multimedia sections; and adapting the multimedia content within the multimedia sections based on the assigned learner-specific evaluations to render the multimedia content more useful to the learner for learning the foreign language.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 shows the architecture of a canonical multimedia system with language learning functionality

FIG. 2 shows the method flow of the system

FIG. 3 shows the architecture of a multimedia input subsystem which, when combined with FIG. 1, enables language learning functionality with DVD input

FIG. 4 shows the architecture of a multimedia input subsystem which, when combined with FIG. 1, enables language learning functionality with streaming media

FIG. 5 shows the architecture of a multimedia input subsystem which, when combined with FIG. 1, enables language learning functionality with DVD input

FIG. 6 shows the architecture of a component section evaluation subsystem which, when combined with FIG. 1, enables analysis of subtitles, audio, and video for learner-specific suitability in language learning

FIG. 7 shows the method flow of a component adaptation and display subsystem which, when combined with FIG. 1 and a component section evaluation subsystem supporting the analysis of subtitles (such as in FIG. 6), enables the modification and display of subtitles for learner-specific suitability in language learning

FIG. 8 shows an internet- and display-connected computing device which implements a multimedia system with language learning functionality

FIGS. 9a-9c show three instances of an audio/video display device which is displaying adapted multimedia content generated by a multimedia system with language learning functionality

FIG. 10 shows a breakdown of component tracks, component sections, and multimedia sections

### DESCRIPTION OF REFERENCE NUMERALS

0.1 External user model input for the system
0.2 External user model interface module
0.3 Multimedia input subsystem
0.7 Multimedia sections, the output of the multimedia input subsystem
0.8 Component section evaluation subsystem, consisting of a set of component evaluation modules
0.9 Section evaluation module
0.10 Section adaptation module
0.11 Display module
0.12 Adapted media output for the system
0.13 External learner feedback input
0.14 Learner feedback interface module
0.15 Section adaptation and display subsystem
1.1 Input multimedia for the method
1.2 External user model input for the method
1.4 Separation of the multimedia into multimedia sections
1.5 Retrieval of the external user model
1.6 Evaluation of component sections
1.7 Combining of component section evaluations into a single multimedia section evaluation
1.8 Adaptation of multimedia using the section evaluation
1.9 Display of results
1.10 Acceptance of learner feedback
1.11 Modification of multimedia adaptation based on learner feedback
1.12 Updating of user model based on learner feedback
2.1 External DVD media input for the system
2.2 DVD demultiplexer
2.3 Audio track output of the DVD demultiplexer
2.4 Video track output of the DVD demultiplexer
2.5 Subtitle track output of the DVD demultiplexer
2.6 Multimedia section module to create component sections and multimedia sections
3.1 External digital media stream input for the system
3.2 Local cache of digital media stream content
3.3 Audio stream output of the digital media stream
3.4 Audio decoder
3.5 Audio track output of the audio decoder
3.6 Video stream output of the digital media stream
3.7 Video decoder
3.8 Video track output of the video decoder
3.9 Subtitle stream output of the digital media stream
3.10 Subtitle decoder
3.11 Subtitle track output of the subtitle decoder
4.1 External DVD media with subtitle overlays input for the system
4.2 Subtitle overlays output of the DVD demultiplexer
4.3 Text identification module
6.1 Audio analysis module to identify number of speakers
6.2 Subtitle analysis module to identify colloquialisms
6.3 Audio analysis module to quantify background noise levels
6.4 Subtitle analysis module to quantify speech difficulty
6.5 Subtitle analysis module to compare subtitle text and audio speech
6.6 Audio analysis module to quantify dialogue speaking speed
6.7 Subtitle analysis module to identify learner vocabulary words
6.8 Video analysis module to identify words visible on-screen
6.9 Subtitle analysis module to quantify grammar used
7.0 Subtitle text
7.1 Component section evaluations
7.2 Decision of whether to display the subtitle text
7.3 Selection of subtitle text language(s)
7.4 Highlighting of relevant study words
7.5 Concealing of words familiar to the learner
7.6 Display of modified subtitle text
8.1 The Internet
8.2 An Internet connection
8.3 Computing device
8.4 Audio/video connection between computing device and display device
8.5 Audio/video display device
8.6 Learner feedback device
9.1 An explosion visible and audible on the display device
9.2 A person visible on the display device
9.3 An unmodified Spanish subtitle corresponding to English speech occurring on the multimedia shown on the display device
9.4 An unmodified English subtitle corresponding to the same multimedia as in 9.3
9.5 An adapted subtitle corresponding to the same multimedia as in 9.3
10.1 An audio component track
10.2 A video component track
10.3 A subtitle component track
10.4 Component section
10.5 Component section
10.6 Component section
10.7 Multimedia section generated from component sections 10.4, which overlaps multimedia section 10.8
10.8 Multimedia section generated from component section 10.5, which overlaps multimedia section 10.7
10.9 Multimedia section generated from component section 10.6

### DETAILED DESCRIPTION OF INVENTION

The invention provides a method and system for adapting multi-track digital multimedia content to make it easier for a foreign-language learner to use in language-learning. Initially the component tracks of the multimedia are isolated and separated into sections for more granular evaluation. After evaluating each of the sections for its learner-specific language learning suitability or difficulty, using a representation of the learner's current knowledge, the multimedia content is adapted to improve the suitability or lower the difficulty for foreign-language learning. The adaptations are applied to the original content and displayed for the learner. Learner feedback is optionally accepted and used to refine the adaptation or update the learner knowledge representation.

The multimedia content includes two or more component tracks, wherein at least one component track can be associated with a foreign language the learner is studying, for example a subtitle track or audio track in the language the learner is studying. The other tracks can be any kind of media, for example, video, audio, text, picture show, and so on.

Based on the suitability or difficulty of the multimedia—for example, the number of difficult words, or the amount of background noise—each section is adapted. A section can be adapted for example, by not displaying the foreign language subtitle track if the words are easy, by displaying the native language if the words are difficult or the background audio is noisy, by highlighting relevant or difficult words for study, or to conceal words.

The foreign-language multimedia content is thus adapted and presented to the user to be used in language learning.

For example, the method could accept as input a film streamed to the learner via the Internet, which is primarily in a foreign language the learner is studying. Analyzing the subtitles, the audio, and the video tracks of the media, a number of sections of the film could be selected for the learner to view that are suitable for study. As each of those sections is presented to the learner, the content could be adapted such that it is more comprehensible, and thus more useful for language learning: background noise could be reduced when it interferes with spoken dialog, and subtitles could be displayed in the language the learner is studying during difficult passages.

This method has the advantage of providing better language-learning adaptations to the learner, owing to its use of a broader range of information contained within authentic multimedia contents, which current solutions do not do. Synthesizing this information in such a way as to be able to relate it to a model representing the learner's knowledge of a foreign language will increase the learner's ability to master the language in question. Furthermore, the disclosed method could be able to adapt any multimedia content for use in language learning, thus making a far greater range of content available to learn from. The learner can select multimedia content of their choice, increasing their engagement with and interest in the language learning process.

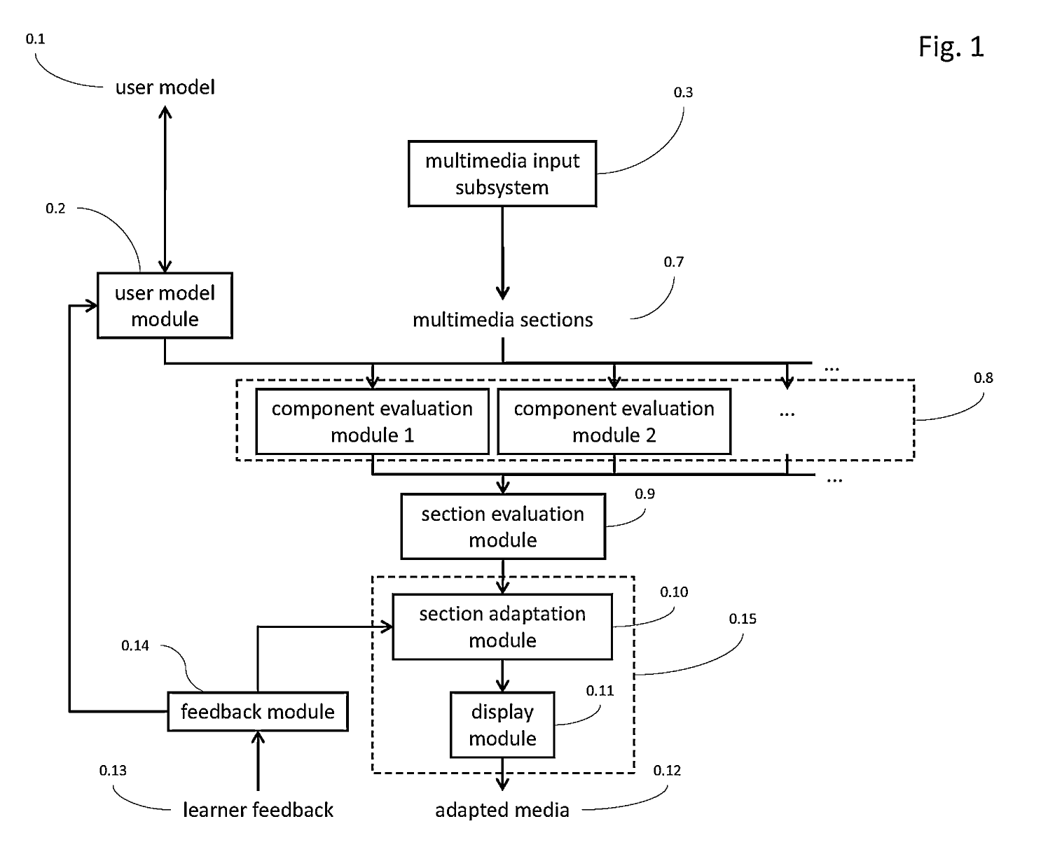

FIG. 1 illustrates a multimedia system with language learning functionality in accordance with one embodiment of the present invention. A multimedia input subsystem 0.3 (of which example embodiments are described later in this document) processes multimedia into a series of possibly overlapping multimedia sections 0.7, which each includes one or more component sections. A component section as referred to herein is a segment of a component track from the multimedia, where a component track could be a video component track, an English audio component track, or a Catalan subtitle component track, for example. A collection of component sections (which could originate from separate component tracks), each of which shares the same start and end, make up a multimedia section.

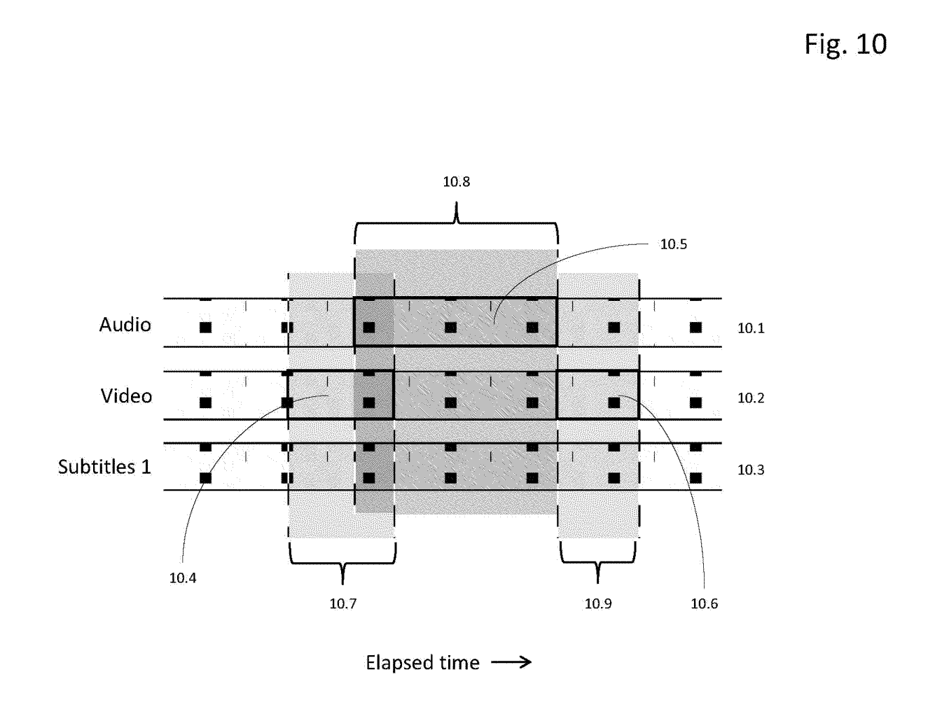

FIG. 10 illustrates one example of the layout of component sections and multimedia sections. Three component tracks are used: an audio component track 10.1, a video component track 10.2, and a subtitle component track 10.3. Each of these component tracks is evaluated to find relevant component sections, where a component section might correspond to a scene, or a conversation, or a single sentence of spoken dialog. One audio component section 10.5 has been identified in the example, along with video component sections 10.4 and 10.6. Each component section has a start time and an end time, and those start and end times may be identified on the other component tracks to generate a multimedia section, which is a collection of component sections, each of which shares the same start and end. In the example, audio component section 10.5 is used to generate multimedia section 10.8, video component section 10.4 is used to generate multimedia section 10.7, and video component section 10.6 is used to generate multimedia section 10.9. There is no prohibition against multimedia sections or component sections overlapping. Also, by sharing the same start and end times it will be understood that the precise start and end times of the component tracks need not be identical. Rather, the start and end times are the same in the sense that the component tracks relate to same scene or dialog during reproduction of the multimedia content.

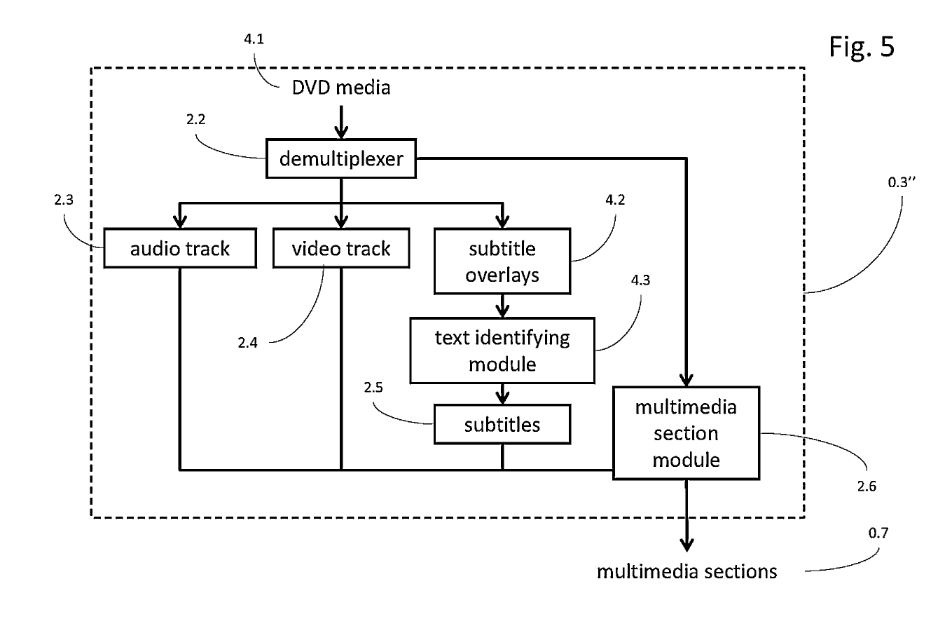

It is to be noted that because the output of multimedia input system 0.3 is multimedia sections, any media may be incorporated into an embodiment of a multimedia input system as long as it is able to be processed into multimedia sections, as described in FIG. 10. The most efficient ways of doing this algorithmically generally require component tracks to be in a digital, machine-readable form. It is possible to use media which is not in such a form if it is first converted to a digital, machine-readable format: for example, the image overlays described in FIG. 5 (later in this document) are processed using a text identification module 4.3 in order to make them machine-readable.

In the exemplary embodiment the multimedia content includes two or more subtitle tracks with one subtitle track having text in a language the learner is studying, and the second track having text in a language the learner is already fluent in (e.g., native language).

An additional input to the system described in FIG. 1 is a previously-derived model of the language-learner's knowledge and/or interests (a “user model”) 0.1. The user model may include information on the learner's mastery or study of the language in question, such as a measure of mastery of vocabulary words the learner knows or is learning, a measure of the learner's speaking fluency, and so forth. The user model may also include information on the learner's preferences for certain types or subsets of media, such as particular genres, dialog between a certain number of people, and so forth. Access and management of the user model's information is controlled through a user model module 0.2, which is responsible for any parsing, formatting, or processing of the user model to make its contents usable by the rest of the system. The user model module is also responsible for modifying the user model as the result of actions occurring during use of the system, such as the learner's language proficiency increasing.

The component section evaluation subsystem 0.8 takes as input the multimedia sections 0.7 and outputs a set of learner-specific component section evaluations for each component section of each multimedia section. The evaluation of each component section is intended to provide one or more measures of the component section's suitability for language learning from the perspective of the learner. Subsystem 0.8 has one or more component evaluation modules that each accepts as input a component section which it can evaluate, and returns an evaluation of that component section's suitability for language-learning. These evaluations may take into account the learner's user model 0.1 by accessing the user model module 0.2, thus providing a learner-specific evaluation of that component section.

The optional section evaluation module 0.9 takes as input the component section evaluations output by subsystem 0.8. It outputs the same set of component section evaluations, but adjusted accordingly as exemplified below.

The component section evaluations from the respective component evaluation modules are used by the section adaptation module 0.10 to adapt the presentation of the multimedia sections in a way that makes the original multimedia content more useful to the learner for language learning. These adaptations are displayed, possibly coincident with the original multimedia, by display module 0.11, resulting in the output of adapted media 0.12.

An optional feedback module 0.14 mediates between learner feedback 0.13 and both the multimedia section adaptations (via the section adaptation module 0.10) and the learner's user model (via the user model module 0.2). Such mediation may involve the learner expressing that they find a multimedia section adaptation less useful, or the learner's response to a test question which then is added to the learner's user model. Feedback may cause multimedia section adaptations to change immediately, or component sections to be re-evaluated based on an updated user model.

It is to be noted that while it may be the case, there is no requirement that any particular modules, inputs or subsystems be located locally in the same physical location; all that is required is that they are able to communicate with each other as described in FIG. 1. For example, multimedia input subsystem 0.3 could be physically located on a server or distributed amongst multiple servers across a content distribution network, and accessed by a component section evaluation subsystem 0.8, located along with the remaining modules and subsystems on a computing device in the learner's home, via the Internet. Alternatively, display module 0.11 could be located in the learner's home, while all other modules and subsystems could be located on one or more remote servers and accessed via the Internet.

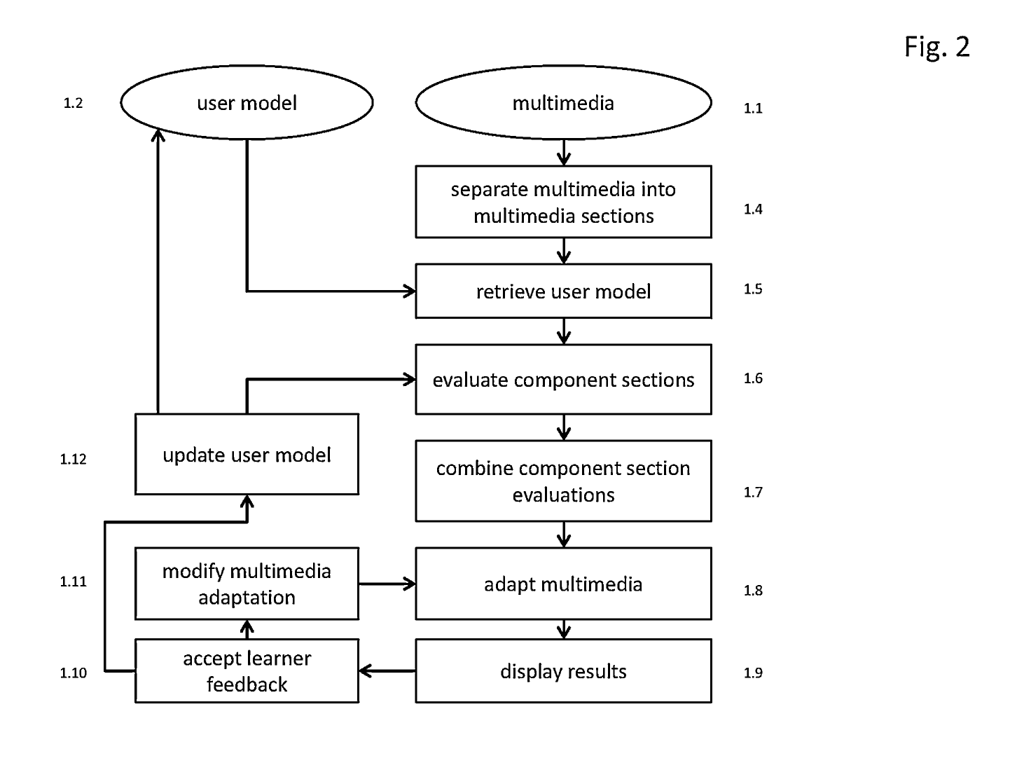

FIG. 2 illustrates the method flow in one embodiment of the present invention. The disclosed method calls for receiving as input via the multimedia input subsystem 0.3 a unit of multimedia content 1.1 capable of being separated into multimedia sections 0.7, as described previously. This separation is accomplished in step 1.4. Step 1.5 retrieves the learner's user model 1.2 from the user model module 0.2.

Step 1.6 evaluates the component sections via the component section evaluation subsystem 0.8 and optionally using the user model, resulting in a set of learner-specific component section evaluations for each component section.

Step 1.7 is optional. In step 1.7 the section evaluation module 0.9 adjusts one or more of the component section evaluations in dependence on the other component section evaluations. For example, a spoken dialog wherein the speech is very fast might be evaluated to be of higher difficulty, but when combined with a vocabulary measurement indicating that the learner knows most of the words spoken, the section evaluation might indicate a lower overall difficulty.

In step 1.8 the section adaptation module 0.10 uses the component section evaluations to adapt the presentation of the multimedia sections in a way that renders the original multimedia content more useful to the learner for language learning. The resulting adapted media is displayed to the learner in step 1.9 by way of the display module 0.11 (e.g., as a corresponding subtitle). Continuing the previous example, if a single word in a moderately-difficult multimedia section is evaluated as completely unknown to the learner, a translation of the word into the learner's native language might be overlaid on the multimedia section as it is displayed.

Optionally, learner feedback 0.13 is accepted in step 1.10 via a user input and may be used to modify or update either the multimedia section adaptations in step 1.11 or the learner's user model 0.2 in step 1.12. Such mediation may involve the learner expressing that they find a multimedia section adaptation less useful, or the learner's response to a test question which then is added to the learner's user model. Feedback may cause multimedia section adaptations to change immediately, or component sections to be re-evaluated based on an updated user model.

It will be appreciated that the present invention is not limited to the precise order shown in FIG. 2. For example, the user model may be retrieved prior to separating the multimedia into multimedia sections.

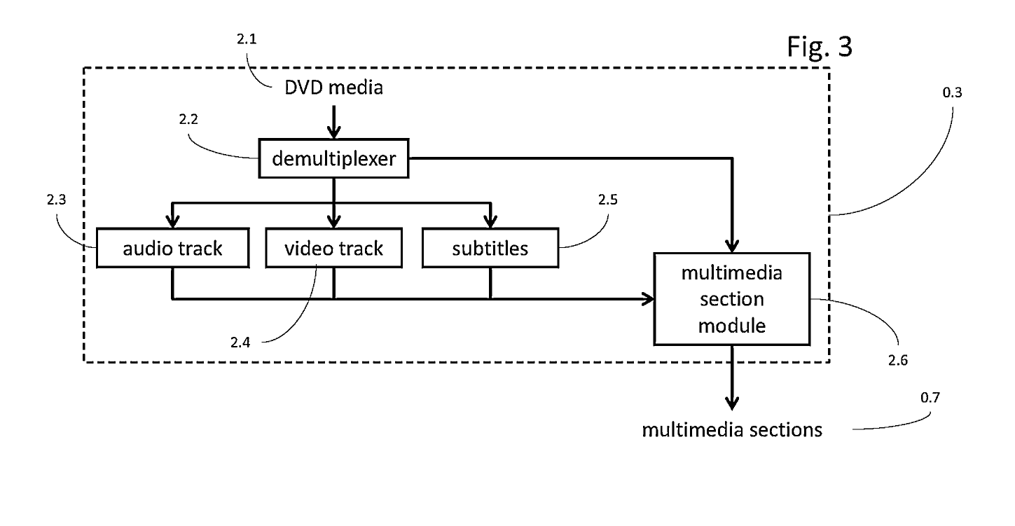

FIG. 3 illustrates a multimedia input subsystem 0.3 of one embodiment of the present invention. The subsystem 0.3 includes as input a unit of DVD media 2.1 (e.g., standard format or Blu-ray), and includes a demultiplexer module 2.2 which separates out the component tracks of the DVD media, resulting in one or more audio tracks 2.3, one or more video tracks 2.4, and one or more subtitle tracks 2.5. These component tracks are analyzed by a multimedia section module 2.6, along with other outputs of the demultiplexer module 2.2 including timing information, scene markers, and so forth. Multimedia section module 2.6 evaluates the component tracks in order to generate component sections, which are used to generate multimedia sections, as described in FIG. 10. The subsystem 0.3 produces multimedia sections 0.7 in accordance with the embodiment presented in FIG. 1 and the example described in FIG. 10.

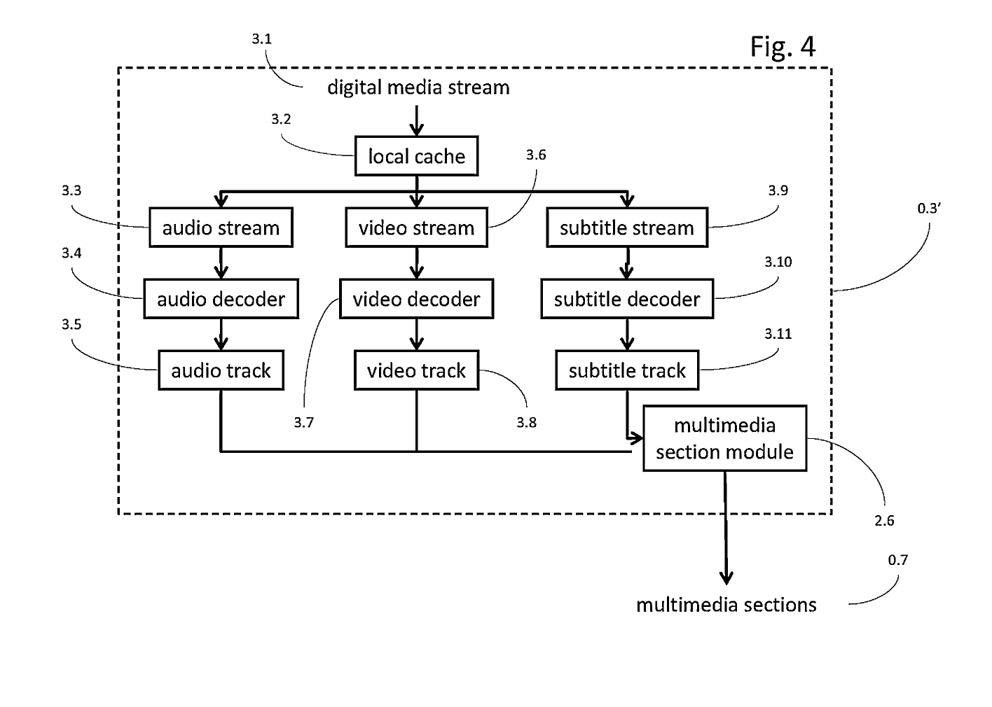

FIG. 4 illustrates a multimedia input subsystem 0.3′ of another embodiment of the present invention. The subsystem 0.3′ requires as input a digital media stream 3.1 such as may be accessed via the Internet. The digital media stream 3.1 is partially or completely stored in a local cache 3.2 and is, if necessary, separated into component streams corresponding to component tracks with the aid of a demultiplexer (not shown). One or more audio streams 3.3 are processed by one or more audio decoders 3.4 which produce one or more audio tracks 3.5. These audio tracks include audio in a language the learner is studying. One or more video streams 3.6 are similarly processed by one or more video decoders 3.7 which produce one or more video tracks 3.8. Two or more subtitle streams 3.9 are similarly processed by one or more subtitle decoders 3.10 to produce two or more subtitle tracks 3.11. These subtitle tracks include one in a language the learner is studying, and also one in a language the learner is already fluent in. Collectively these tracks are analyzed by a multimedia section module 2.6. The subsystem 0.3′ produces multimedia sections 0.7 in accordance with the embodiment presented in FIG. 1 and the example presented in FIG. 10.

In a further embodiment, the digital media stream 3.1 and the local cache 3.2 could be replaced by a locally-stored digital media file, which would function identically to a local cache 3.2 containing the locally-stored digital media file, and would in all other respects be identical to the embodiment presented in FIG. 4.

FIG. 5 illustrates a multimedia input subsystem 0.3″ of another embodiment of the present invention. The subsystem 0.3″ requires as input a unit of DVD media 4.1 which is functionally identical to that of FIG. 3, with the exception that the subtitles are rendered as image overlays instead of digital textual data. The demultiplexer 2.2, the audio track output 2.3, and the video track output 2.4 remain identical to those described in FIG. 3. One or more subtitle overlays 4.2 are processed by a text identification module 4.3 to identify the text contained therein, using known methods in the prior art such as optical character recognition. The output subtitles 2.5 are identical to those described in FIG. 3. The component tracks are analyzed by a multimedia section module 2.6, along with other outputs of the demultiplexer. The subsystem 0.3″ produces multimedia sections 0.7 in accordance with the embodiment presented in FIG. 1 and the example presented in FIG. 10.

A further embodiment of a multimedia input subsystem 0.3 includes an electronic book which includes one of more audio tracks or translations, where the audio tracks and translations correspond or can be made to correspond directly at a sentence-by-sentence level with the original book text. This could allow component sections and multimedia sections to be created with a minimum granularity of a sentence. The subsystem could produce multimedia sections 0.7 in accordance with the embodiment presented in FIG. 1 and the example presented in FIG. 10.

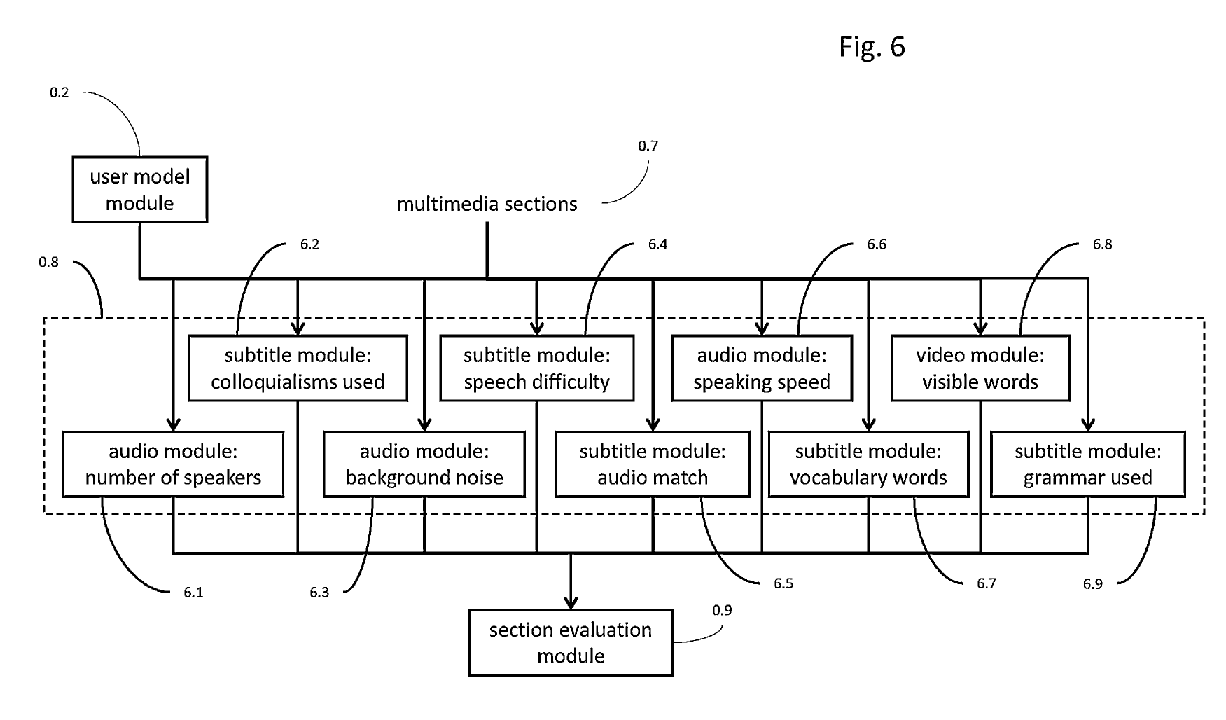

FIG. 6 illustrates a component section evaluation subsystem 0.8 of an exemplary embodiment of the present invention. The subsystem comprises one or more modules, each of which evaluates one aspect of the input multimedia as it relates to foreign language learning from the perspective of the learner. Each module accepts as input one or more multimedia sections 0.7, and outputs an evaluation of one or more of the component sections of the multimedia sections that it is designed to handle.

The exemplary embodiment has component section evaluation modules 6.1-6.9, as described below. However, any number of such modules is permitted. Moreover, any specific methods can be used to make evaluations, and any manner of representing the evaluations is permissible.

Audio component evaluation module 6.1 identifies the number of speakers present in a multimedia section, and automatically outputs or assigns a numerical difficulty rating related to that number. The numbers of speakers are identified through known methods in the prior art, such as those involving the recognition of different speech patterns (where each different speech pattern corresponds to a separate speaker). Difficulty can be assigned in numerous ways. In the exemplary embodiment, a numerical difficulty rating is assigned to the multimedia section irrespective of the learner's user model in this case, where the difficulty rating is equal to the number of speakers, up to a maximum of five speakers (a “very difficult” dialog by this measure).

Subtitle component evaluation module 6.2 identifies colloquialisms present in a multimedia section, evaluates the difficulty for the current user, and outputs a numerical score representing this difficulty. The evaluation can be made based on known methods in the prior art; for example, a comparison between a dictionary of colloquialisms and a subtitle text component section in the language the learner is studying. A numerical difficulty rating is automatically assigned to the multimedia section based on several factors: whether or not the learner has previously encountered the colloquialism (data on which is contained in the learner's user model), how well the learner knows the colloquialism (again based on the learner's user model), and how difficult the colloquialism is for a foreign speaker to understand (which is based on a manual evaluation metric contained within the dictionary). In the exemplary embodiment, a numerical difficulty rating is derived beginning with the percentage of words (represented by a number between 0 and 1) in the multimedia section which falls within any colloquialism. This rating is increased by ten percent for each colloquialism the learner has not encountered before. The rating is multiplied by the average of how well the learner knows each of the colloquialisms present in the multimedia section, given as a numerical score ranging from 0 to 1, where a lower number corresponds to the learner knowing a colloquialism better. The rating is also multiplied by the average difficulty of the colloquialisms in the sentence, from the perspective of the learner; this difficulty is again represented by a number ranging from 0 to 1, where a lower number indicates a lower difficulty. Once a final difficulty rating for the multimedia section is calculated, the result is normalized so that it falls within a range from 0 to 5.

Audio component evaluation module 6.3 evaluates the level of background noise (i.e. sound that is not dialog speech) and automatically outputs or assigns a numerical difficulty rating representing that level. This evaluation can be completed based on known methods in the prior art, such as a measure of continuous noise present in an audio component section or a measure of the remainder following a “subtraction” of audio associated with speech from an audio component section. A numerical difficulty rating could be assigned to the component section based on an absolute measure of the level of background noise, or based on a measure of the background noise compared to the average level of dialog speech. In the exemplary embodiment, the difficulty rating is a number between 0 and 5, where 0 corresponds to no appreciable background noise, and 5 corresponds to an extremely high level of background noise.

Subtitle component evaluation module 6.4 evaluates the difficulty of dialog speech for the learner, and automatically outputs or assigns a numerical difficulty rating representing it. This evaluation can be completed using known methods in the prior art such as identification of poorly-formed or grammatically incorrect speech via grammatical evaluation algorithms and spell-checking. A numerical difficulty rating could be assigned to the component section based on the number of incorrectly-formed or -spelled instances, with a high difficulty rating corresponding to a high number of incorrect instances. The difficulty rating could be reduced if the learner's user model includes a rating of their ability to comprehend poorly-formed speech in the appropriate language, and that rating is sufficient to indicate that the learner would not be impeded by the presence of some of the incorrect instances. In the exemplary embodiment, the difficulty rating for the base dialog speech is a number from 0 to 5 (where 5 represents dialog speech of the highest difficulty), and it is multiplied by a number between 0.5 and 1 representing the learner's ability to comprehend poorly-formed speech (where 0.5 represents maximal ability to comprehend poorly-formed speech).

Subtitle component evaluation module 6.5 evaluates how accurately subtitles of the multimedia section to be analyzed match accompanying dialog speech in the audio component track, and automatically outputs or assigns a numerical difficulty rating representing that accuracy. This is accomplished via known methods in the prior art such as performing speech-to-text translation on an audio component section and comparing the result to text extracted from a subtitle component section. A numerical difficulty rating could be assigned to the component section based on the percentage of words occurring in both the speech-to-text translation and the subtitle component section, with a lower percentage corresponding to a higher difficulty of comprehension (owing to the learner reading one version of dialog but hearing another). In the exemplary embodiment, the difficulty rating is this percentage, scaled inversely so that it runs from 0 to 5 (5 representing a 0% match, the highest possible difficulty).

Audio component evaluation module 6.6 evaluates the speed of dialog speech and automatically outputs or assigns a numerical difficulty score representing that speed. This is accomplished using known methods in the prior art such as speech-to-text identification and a computation to identify syllable counts for each word. A numerical difficulty rating could be assigned to the component section based on the highest number of words or syllables which are spoken during a given time span, with faster-spoken dialog being evaluated as more difficult. In the exemplary embodiment the difficulty rating is calculated by taking the average number of syllables per minute over the entire multimedia section, dividing it by 40, and reducing any result higher than 5 to 5. The resulting difficulty rating falls between 0 and 5, with a 5 representing the most difficult speech, that with 200 or more syllables per minute.

Subtitle component evaluation module 6.7 evaluates vocabulary present in dialog speech from the perspective of the learner and automatically outputs or assigns a numerical difficulty rating representing that difficulty. This is accomplished using known methods in the prior art such as comparison with the learner's user model and a measure of the frequency of word occurrences in other real-world text. A numerical difficulty rating could be assigned to the component section based on the percentage of words the learner knows (according to the learner's user model) and the difficulty of dialog words, based on how often they occur in a large body of real-world text. An additional difficulty modifier could be applied for those words which are both of high difficulty and fall outside the learner's vocabulary according to their user model. In the exemplary embodiment the difficulty rating is derived beginning with the percentage (represented as a number between 0 and 1) of words in the multimedia section which the learner does not know, according to their user model. This number is multiplied by the average frequency of the words in some large body of texts, scaled inversely so that the highest-frequency words have a frequency greater than 0 and the lowest-frequency words have a frequency of 1. The final difficulty rating is scaled so that it falls between 0 and 5, with a 5 representing a multimedia section containing only difficult words which the learner does not know.

Video component evaluation module 6.8 evaluates any words in a language the learner is studying which are visible on-screen but do not necessarily occur in dialog speech, and automatically outputs or assigns a numerical difficulty rating representing an increased difficulty in the multimedia section based on that correspondence. This could be accomplished via known methods in the prior art such as text recognition performed across individual frames of a video component section. A numerical difficulty rating could be assigned to the component section based on the number and size of words occurring in a given multimedia section or in a given time frame, where a high number of words present on the screen could indicate an increased cognitive load for the learner and thus a higher difficulty for the component section. In the exemplary embodiment the difficulty rating is derived beginning with the total number of words which appear on-screen over the whole of the multimedia section, divided by five and with the result capped at a maximum value of five. This difficulty rating is multiplied by the percentage of those words (represented as a number between 0 and 1) which do not occur in the dialog of the multimedia section.

Subtitle component evaluation module 6.9 evaluates the difficulty of grammar constructions occurring in dialog speech for the learner, and automatically outputs or assigns a numerical difficulty rating representing it. This is accomplished using known methods in the prior art such as pattern matching and sentence parsing, or comparisons to an external dictionary of grammar constructions. A numerical difficulty rating could be assigned to the component section based on grammar constructions the learner has not studied yet (according to their user model), or based on a difficulty rating contained within an external dictionary, where a higher number of difficult grammar constructions or constructions the learner has not studied correspond to a higher difficulty for the component section. In the exemplary embodiment the difficulty rating is calculated in a manner identical to that described for module 6.7, but with grammar constructions substituted for vocabulary words.

It is to be noted that there is no requirement that component evaluation modules produce difficulty ratings which are strictly numerical. For example, subtitle component evaluation module 6.7 could produce a computational model of the vocabulary contained within a particular sentence. This model could be queried to find out how likely the learner is to know a specific word in the sentence (effectively a function which accepts a word in the sentence and returns the probability of the learner knowing that word).

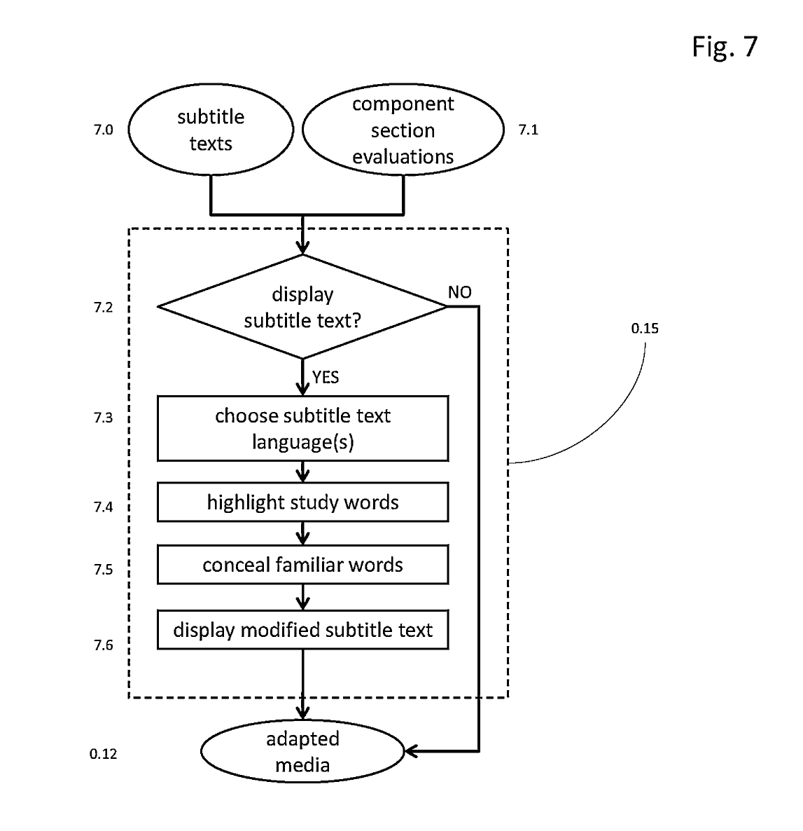

FIG. 7 illustrates a process carried out by a component adaptation and display subsystem 0.15 of the exemplary embodiment of the present invention. The method accepts as input a set of subtitle texts 7.0 corresponding to a section of a unit of multimedia content, with the subtitle texts containing at least subtitle text meant for native speakers of a foreign language the learner is studying, and subtitle text meant for native speakers of a language the learner is already fluent in. The method additionally requires a learner-specific evaluation 7.1 of the subtitle texts 7.0 such as would be produced by a section evaluation module such as that described in component section evaluation subsystem 0.8. This learner-specific evaluation 7.1 will inform the decisions to be made in steps 7.2-7.7, and will enable the method to produce results personalized to the learner.

Step 7.2 selects whether or not to display any subtitle text at all; for example, if the subtitle text contains only very easy vocabulary words and grammar constructions (where “very easy” corresponds to a difficulty rating of less than 1 as evaluated by both subtitle evaluation modules 6.7 and 6.9), and is a close match for the spoken audio (corresponding to a difficulty rating of less than 2 as evaluated by component evaluation module 6.5), the text will not be displayed.

Similarly, if the subtitle text is not a close match to the spoken audio (a difficulty rating greater than 4 according to subtitle evaluation module 6.5), or if there is a high level of background noise (a difficulty rating greater than 4 according to component evaluation module 6.3), the subtitle text is displayed in whole or in subset part. For example, the display of the subtitle text may be limited only to certain words within the spoken audio that present a high level of difficulty. As referred to herein, the “displaying of subtitle text” can include displaying all of the subtitle text corresponding to a multimedia section, or merely a subset of the subtitle text, as preferred.

Step 7.3 selects one or more languages to use in displaying the subtitle text. For example, if one phrase of spoken audio is obfuscated by background noise (corresponding to a difficulty rating greater than 4 as evaluated by component evaluation module 6.3) the corresponding phrase of subtitle text could be displayed in the learner's native language. If one phrase of subtitle text is considered of moderate difficulty for the learner (a difficulty rating greater than or equal to 1 but less than or equal to 4 according to subtitle evaluation module 6.7), that phrase could be displayed in the language the learner is studying.

Step 7.4 selectively highlights relevant words or phrases that the learner is studying; this information could be contained within the learner's user model 0.1. Highlighting can optionally be in multiple colors or shades so as to further delineate words or phrases. For example, a word or phrase that the learner's user model identifies as immediately relevant (according to a list of “current study words” in the learner's user model and with a difficulty rating greater than 2 according to subtitle evaluation module 6.7) could be highlighted in a bright red color, while a word or phrase that the user learned just recently (according to a list of “recently studied words” in the learner's user model and with a difficulty rating greater than 1 according to subtitle evaluation module 6.7) could be highlighted in a more muted orange color. This will draw a learner's attention to words that are particularly important for their current and most recent studies.

Step 7.5 selectively conceals words familiar to the learner. For example, a word that the learner has complete mastery of (a difficulty rating of 0 according to subtitle evaluation module 6.7) will be hidden from view. This encourages the learner to listen to the audio (which will likely be spoken in the language the learner is studying) and will thus improve their comprehension of spoken words.

The results of the previous four steps are applied to the subtitles in succession and the resulting modified subtitle text displayed in step 7.6, in a manner consistent with how subtitles are usually displayed (generally at the bottom of the screen of the display module 0.11, overlaying the picture). When combined with the normal audio/video output of the media display device this results in adapted media 0.12 being displayed to the learner.

A further embodiment of the present invention includes optional section evaluation module 0.9. The section evaluation module 0.9 is responsible for adjusting each component section evaluation output by subsystem 0.8 in a way that takes into account the component section evaluation's results relative to other component section evaluations and to the learner's user model.

For instance, working from the previous examples, the component section evaluation of audio component evaluation module 6.1 might have its numerical difficulty rating doubled if the component section evaluation of subtitle component evaluation module 6.4 is over a certain threshold (representing an exponential increase in difficulty in the case of a high number of speakers using poorly-formed speech).

Similarly, the component section evaluation of subtitle component evaluation module 6.2 might have its numerical difficulty rating doubled if the component section evaluation of subtitle component evaluation module 6.5 is higher than a certain level of difficulty. This might indicate that a particular colloquialism has not been literally translated, making comprehension more difficult for the learner.

Similarly, the component section evaluation of audio component evaluation module 6.3 might have its numerical difficulty rating reduced to zero (indicating an easy rating) if the number of speakers identified by audio component evaluation module 6.1 is zero, indicating there is no dialog speech in this particular multimedia section (and thus no increase in difficulty hearing that speech due to background noise).

Similarly, the component section evaluation of subtitle component evaluation module 6.5 might have its numerical difficulty rating reduced if the component section evaluation of subtitle component evaluation module 6.4 is over a certain threshold. This correspondence could indicate that the disparity between the dialog speech and displayed subtitles (represented by the numerical difficulty rating from module 6.5) is due to errors in the subtitles themselves (represented by the numerical difficulty rating from module 6.4), as opposed to, for example, an intentional change in translation from dialog speech to subtitle text which omitted key words or phrases.

Similarly, the component section evaluation of audio component evaluation module 6.6 might have its numerical difficulty rating increased if the component section evaluations of subtitle component evaluations 6.7 and 6.9 are above a certain threshold, representing fast speech made more difficult due to the learner not being able to understand many of the words or grammar constructions.

Similarly, the component section evaluation of subtitle component evaluation module 6.7 might have its numerical difficult rating increased if the component section evaluation of subtitle component evaluation module 6.5 is over a certain threshold, representing vocabulary words the learner is less familiar with being more difficult (represented by the numerical difficulty rating from module 6.7) due to their being part of subtitle text but not dialog speech (represented by the numerical difficulty rating from module 6.5).

A similar technique to the preceding could be used for the component section evaluation of subtitle component evaluation module 6.9, with grammar constructions substituting for vocabulary words.

Similarly, the component section evaluation of video component evaluation module 6.8 might have its numerical difficulty rating increased if the component section evaluation of audio component evaluation module 6.1 is over a certain threshold, representing increased difficulty for the learner to read onscreen text (represented by the numerical difficulty rating from module 6.8) due to higher cognitive demand from multiple speakers (represented by the numerical difficulty rating from module 6.1).

A further embodiment of a component adaptation and display subsystem 0.15 consists of one which optionally accepts learner feedback 0.13 in response to the learner's viewing of the adapted media. This feedback could include an indication that the learner finds the adapted media too difficult to comprehend, or similarly that the learner finds the adapted media too easy. The feedback could be delivered by a dedicated device or by interpreting a signal from a pre-existing device, such as a television remote control. After receiving the feedback the method modifies the evaluation of the text to reflect the learner's current preference. This modification could be a temporary change that persists only until the end of the learner's current viewing session, or it could be reflected more permanently by modifying the learner's user model 1.2. Changes to the learner's user model could be reflected in future component section evaluation as described in FIG. 6.

A further embodiment of a process carried out by a component adaptation and display subsystem 0.15 consists of one which switches between the display of two different sets of subtitles, one intended for speakers of a language the learner is fluent in, and one intended for speakers of a language the learner is studying. The method could display subtitles in the language the learner is fluent in when the difficulty of the multimedia section is rated above a certain level (indicating very difficult dialogue from the learner's perspective), and could display subtitles in the language the learner is studying at all other times.

A further embodiment of a process carried out by a component adaptation and display subsystem 0.15 consists of one which selects only those multimedia sections which are most useful or relevant to the learner, based on their evaluations, and displays them to the learner. Adapting the multimedia content in this embodiment, for example, includes simply selecting whether or not to display the multimedia content in each given multimedia section. As a particular example, the foreign or native language subtitle in a given multimedia section is selectively displayed or not displayed based on the determined usefulness or relevance to the leaner. This would maximize the learner's ability to comprehend the multimedia sections while retaining their utility for language learning.

A further embodiment of a process carried out by a component adaptation and display subsystem 0.15 consists of one which reduces the background noise of a multimedia section when it is evaluated as being a significant obstacle to dialog which would otherwise be accessible to the learner. This could improve the learner's ability to hear dialog clearly.

A further embodiment of a process carried out by a component adaptation and display subsystem 0.15 consists of one which notifies the learner, via an on-screen notification, that the current multimedia section being viewed is at an appropriate level (based on the evaluation of the multimedia section) for the learner to use in their study. This could allow the learner to switch to a different mode of media presentation suitable for improving their study, such as that described in FIG. 7.

A further embodiment of a process carried out by a component adaptation and display subsystem 0.15 consists of one which considers a single multimedia section made up of the complete unit of media, and notifies the learner how suitable the media as a whole is for language-learning by that learner, based on the multimedia section evaluation. This evaluation would function identically to that described in FIG. 6, but with a larger input comprising the complete unit of media. This would allow the learner to better select between different pieces of media for use in language learning.

A further embodiment of a process carried out by a component adaptation and display subsystem 0.15 consists of one which highlights vocabulary words the learner is studying which are present in a subtitle component section as they're being spoken in audio dialog contained within a corresponding audio component section. This would help the learner associate spoken audio with written vocabulary.

A further embodiment of a process carried out by a component adaptation and display subsystem 0.15 consists of one which administers a quiz or test to the learner after they have completed a session of multimedia viewing. The learner's responses represent feedback which could be used to measure the learner's acquisition of the concepts, vocabulary, etc which are contained in the multimedia which was just viewed. The results of the quiz could modify the learner's user model such as is described in 7.8.

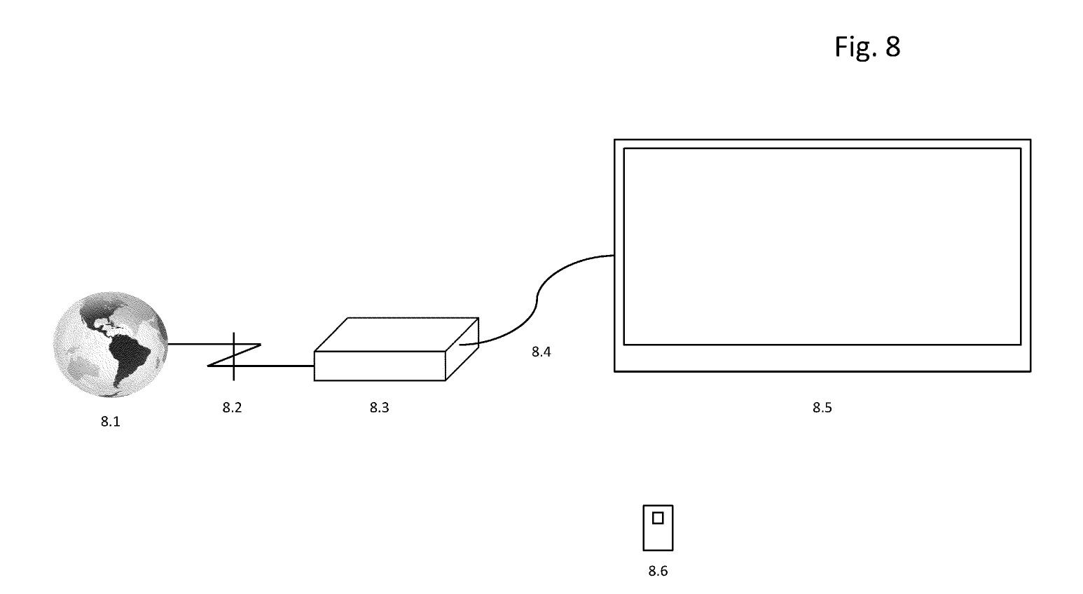

FIG. 8 illustrates an Internet- and display-connected computing device implementing a multimedia system with language learning functionality, similar to that described in FIG. 1, in accordance with an embodiment of the present invention. A computing device 8.3 including one or more processor programmed as discussed herein connects to the Internet 8.1 via an Internet connection 8.2. This Internet connection can provide remote access to the media used as input 3.1 or access to the user model 0.2, neither of which is required to be stored locally. The computing device 8.3 is also connected to an audio/visual display device 8.5 by an audio/video connection 8.4. This display device, representing the display module 0.11, can be used as the final output for the adapted media 0.12, and some part or related accessory of it (such as a remote control 8.6) can be used as an input device for the learner to deliver external learner feedback 0.13.

A further embodiment of a display-connected computing device 8.3 implementing a multimedia system with language learning functionality in accordance with the invention could be an electronic book, including a display and a hard drive contained within the electronic book which stores content (digital versions of books, magazines, and so forth). Such a system could utilize a component track corresponding to the original text of the book, a component track corresponding to a spoken version of the text, and a user model loaded onto the electronic book via a wireless connection or a USB cable to produce learner-specific adapted media in a manner similar to that described in FIG. 1.

A further embodiment of a display-connected computing device 8.3 implementing a multimedia system with language learning functionality could be one similar to that illustrated in FIG. 8, but with a feedback mechanism which administered a quiz or test to the learner after they had completed a session of multimedia viewing (a state which could be identified by a computing device 8.3). In such a case the remote control 8.6 could be a device such as an Internet-connected smartphone, which could be notified by the computing device 8.3 via the Internet that a quiz should be administered. The smartphone could then automatically administer an external quiz or test to the learner and accept their responses.

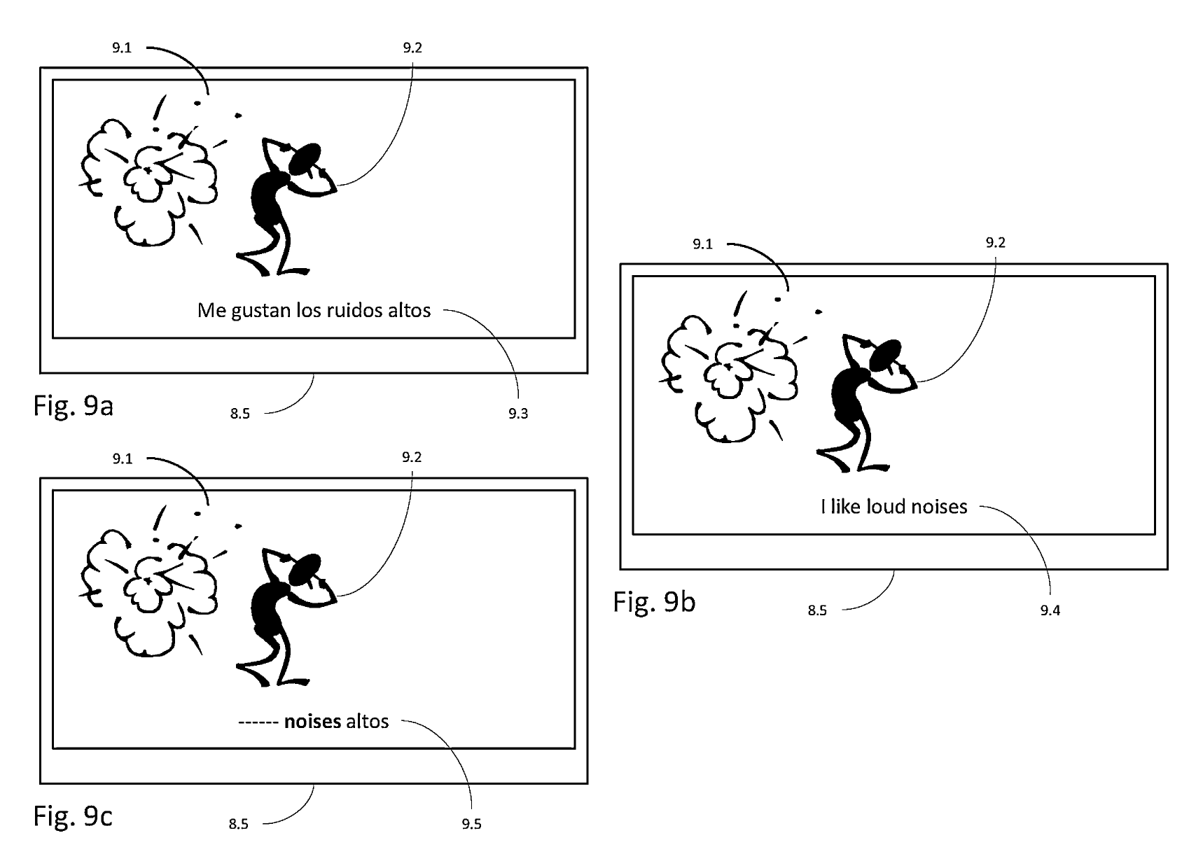

FIGS. 9a-c illustrate three instances of an audio/video display device 8.5 implementing an exemplary embodiment of a multimedia system with language learning functionality, as described in FIG. 4, FIG. 6, and FIG. 7. A scene in a multimedia presentation being shown on the display device 8.5 depicts an explosion 9.1 and a person 9.2 who is speaking in English.

FIG. 9a illustrates an unmodified Spanish subtitle 9.3, as might be included on a Spanish subtitle track of the multimedia presentation (e.g., for the hearing impaired).

FIG. 9b illustrates the English subtitle 9.4 which is a translation of subtitle 9.3, as might be included on an English subtitle track of the multimedia presentation (e.g., for non-Spanish speakers).

FIG. 9c illustrates an adapted subtitle 9.5 which is the output of a multimedia system with language learning functionality, such as that described in FIG. 4, FIG. 6, and FIG. 7. The subtitle 9.5 is adapted for use by a learner who is a native speaker of Spanish, and is learning English. In this instance the system has extracted both the Spanish and the English subtitles, and has adapted the subtitles based on the noise level from the explosion 9.1 (by audio component evaluation module 6.3), the presence of one character 9.2 in the scene (by audio component evaluation module 6.1), the lack of visible words in the scene (by video component evaluation module 6.8), and the learner's user model (not pictured). The first few words are considered very easy for the learner to hear (as evaluated by audio evaluation modules 6.1, 6.3, and 6.6) and to understand (as evaluated by subtitle evaluation modules 6.2, 6.4, 6.5, 6.7, and 6.9); they are left blank (see step 7.2 above). The word for “noises” is considered more difficult (as evaluated by the previously-mentioned set of subtitle evaluation modules), and is one of the words the learner is studying (recorded in the learner's user model), and, in a manner similar to that described in FIG. 7, it is thus displayed in English and bolded to draw attention to it (see step 7.4 above). The word for “loud” is considered too difficult for the learner when considering the increased difficulty of hearing it spoken over the explosion (as evaluated by the previously-mentioned set of subtitle evaluation modules and audio evaluation module 6.3), and it is displayed in the learner's native Spanish to maximize comprehension (see step 7.3 above).

The particular modules, inputs and subsystems described herein in accordance with the invention are computer-based in that they may be implemented via any suitable combination of hardware and software. For example, the multimedia input subsystem 0.3, component evaluation modules 0.8, section evaluation module 0.9, section adaptation module 0.10, display module 0.11, feedback module 0.14 and user model module 0.2 may be constituted by one or more computing devices (e.g., computer processors or controllers) programmed to carry out the specific functions and operations described herein. Specifically, the one or more computing devices may be programmed to execute one or more machine readable programs (collectively referred to herein as a computer program) each stored on a non-transitory computer readable medium or mediums (e.g., static or dynamic digital memory such as RAM, ROM, hard drive, optical drive, solid-state drive, etc.) in order to carry out the corresponding module functions. Based on the disclosure provided herein, a person having ordinary skill in the field of computer programming will readily understand how to program one or more computing devices to perform the functions and operations described herein with respect to the particular modules, inputs and subsystems, using known programming techniques. Accordingly, further detail as to specific programming code has been omitted for sake of brevity. The present invention includes such a computer program stored on a non-transitory computer readable medium.

As will be further appreciated, for example, in the case of the multimedia input subsystem of embodiments of FIGS. 2 and 4 the multimedia input subsystem includes a DVD-type optical drive which reads the multimedia from a DVD disk. In the embodiment of FIG. 4, the multimedia input subsystem may include an appropriate network interface (e.g., wired or wireless) for receiving the digital media stream from the content source. The display module 0.11 may include any type of suitable display such as flat panel, LCD, LED, plasma, e-ink, etc.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The method, system and program can be implemented in any situation where digital multimedia is delivered to an audio/video display device. Such situations could include ones such as a DVD player which has a self-contained user model and is connected to a TV, to ones such as an Internet service where the user model is stored online and streaming media is delivered via the Internet directly to the learner's screen (such as is described in the exemplary embodiment above). It is further contemplated to apply this to non-video-based forms of multimedia as well, such as books with an accompanying soundtrack or an accompanying audio version of the text.

1. A multimedia-based language learning method, comprising:
implementing via one or more processors the steps of—
receiving an input of multimedia content, wherein the multimedia content comprises a plurality of component tracks including an audio component track;
separating the multimedia content into multimedia sections in which the plurality of component tracks share a same start and end time;
retrieving a user model representing a learner's knowledge and/or interest in a foreign language;
automatically assigning one or more learner-specific evaluations to the multimedia sections by evaluating one or more of the component tracks based on the user model within each of the multimedia sections including evaluating the audio component track based on the user model and at least one of number of speakers, background noise and speaking speed; and
adapting the multimedia content within the multimedia sections based on the assigned learner-specific evaluations to render the multimedia content more useful to the learner for learning the foreign language.

2. The method according to claim 1, wherein the user model comprises vocabulary words the learner knows and/or is interested to learn.

3. The method according to claim 1, wherein the plurality of component tracks comprises a subtitle component track in the foreign language

4. The method according to claim 3, wherein the step of adapting the multimedia content comprises adapting content of the subtitle component track.

5. The method according to claim 3, wherein the subtitle component track is evaluated based on the user model in the step of assigning the one or more learner-specific evaluations.

6. The method according to claim 5, wherein the subtitle component track is evaluated based on at least two of colloquialisms, grammar, vocabulary, speech difficulty, and accuracy in matching accompanying dialog in an audio component track, wherein speech difficulty corresponds to the number of incorrectly-formed or incorrectly-spelled instances.

7. The method according to claim 4, wherein the subtitle component track is adapted by at least one of selectively displaying subtitle text, displaying the subtitle text in the foreign language and/or a native language, highlighting relevant words or phrases in the subtitle text, and concealing words in the subtitle text familiar to the learner.

8. The method according to claim 7, wherein the subtitle component track is adapted by displaying the subtitle text in the native language or a combination of the foreign and native language.

9. The method according to claim 1, wherein the multimedia content is adapted only in the multimedia sections determined to be most useful or relevant to the learner.

10. The method according to claim 1, wherein the step of adapting the multimedia content comprises respectively selecting for each multimedia section whether to display the multimedia content based on the assigned learner-specific evaluations.

11-12. (canceled)

13. The method according to claim 1, wherein when the background noise of the audio component track is evaluated as being an obstacle to dialog which would otherwise be accessible to the learner, the audio component track is adapted by reducing the background noise.

14. The method according to claim 1, wherein a video component track within the plurality of component tracks is evaluated based on the user model in the step of assigning the one or more learner-specific evaluations.

15. The method according to claim 1, wherein the one or more learner-specific evaluations include a plurality of learner-specific evaluations.

16. The method according to claim 15, wherein a one of the plurality of learner-specific evaluations is adjusted taking into account another one of the learner-specific evaluations.

17. The method according to claim 1, comprising accepting feedback from the learner based upon which the one or more learner-specific evaluations are modified.

18. The method according to claim 17, wherein the feedback is the learner's responses to a quiz.

19. The method according to claim 1, wherein the input of multimedia content is received from at least one of an optical disk and streaming media.

20. A multimedia-based language learning system, comprising:
one or more processors and a non-transitory, computer-readable medium storing a program, the one or more processors executing the program to carry out the steps of—
receiving an input of multimedia content, wherein the multimedia content comprises a plurality of component tracks including an audio component track;
separating the multimedia content into multimedia sections in which the plurality of component tracks share a same start and end time;
retrieving a user model representing a learner's knowledge and/or interest in a foreign language;
automatically assigning one or more learner-specific evaluations to the multimedia sections by evaluating one or more of the component tracks based on the user model within each of the multimedia sections including evaluating the audio component track based on the user model and at least one of number of speakers, background noise and speaking speed; and
adapting the multimedia content within the multimedia sections based on the assigned learner-specific evaluations to render the multimedia content more useful to the learner for learning the foreign language.

21. The system according to claim 20, wherein the user model comprises vocabulary words the learner knows and/or is interested to learn.

22. The system according to claim 20, wherein the plurality of component tracks comprises a subtitle component track in the foreign language

23. The system according to claim 22, wherein the step of adapting the multimedia content comprises adapting content of the subtitle component track.

24. The system according to claim 22, wherein the subtitle component track is evaluated based on the user model in the step of assigning the one or more learner-specific evaluations.

25. The system according to claim 24, wherein the subtitle component track is evaluated based on at least two of colloquialisms, grammar, vocabulary, speech difficulty, and accuracy in matching accompanying dialog in an audio component track, wherein speech difficulty corresponds to the number of incorrectly-formed or incorrectly-spelled instances.

26. The system according to claim 23, wherein the subtitle component track is adapted by at least one of selectively displaying subtitle text, displaying the subtitle text in the foreign language and/or a native language, highlighting relevant words or phrases in the subtitle text, and concealing words in the subtitle text familiar to the learner.

27. The system according to claim 26, wherein the subtitle component track is adapted by displaying the subtitle text as a combination of the foreign and native language.

28. (canceled)

29. A non-transitory, computer-readable medium having stored thereon a program when executed by a computer carries out a method of multimedia-based language learning, comprising:
receiving an input of multimedia content, wherein the multimedia content comprises a plurality of component tracks including an audio component track;
separating the multimedia content into multimedia sections in which the plurality of component tracks share a same start and end time;
retrieving a user model representing a learner's knowledge and/or interest in a foreign language;
automatically assigning one or more learner-specific evaluations to the multimedia sections by evaluating one or more of the component tracks based on the user model within each of the multimedia sections including evaluating the audio component track based on the user model and at least one of number of speakers, background noise and speaking speed; and
adapting the multimedia content within the multimedia sections based on the assigned learner-specific evaluations to render the multimedia content more useful to the learner for learning the foreign language.
